(19) United States
(12) Patent Application Publication
(10) Pub. No.: US 2022/0042811 A1
(43) Pub. Date: Feb. 10, 2022

(54) METHOD AND SERVER

(71) Applicant: Toyota Jidosha Kabushiki Kaisha, Toyota-shi Aichi-ken (JP)

(72) Inventors: Tetsushi Okamoto, Nisshin-shi (JP); Kazumi Aono, Gamagori-shi (JP); Naoki Uenoyama, Nagoya-shi (JP); Equan Tompkins, Aubrey, TX (US)

(21) Appl. No.: 17/394,945

(22) Filed: Aug. 5, 2021

(30) Foreign Application Priority Data
Aug. 7, 2020 (JP) 2020-135356

(51) Int. Cl. G01C 21/34; G01C 21/36

(52) U.S. Cl. CPC G01C 21/3438; G01C 21/3492; G01C 21/3605

(57) ABSTRACT

A method executed by a terminal apparatus includes transmitting and receiving one or more instant messages among a plurality of users, acquiring a period for sharing positional information among the plurality of users, the period being determined based on a meeting time for the plurality of users that is acquired from the instant messages, activating a function of sharing positional information among the plurality of users, when the period starts, and deactivating the function when the period ends.

### CROSS-REFERENCE TO RELATED APPLICATION

This application claims priority to Japanese Patent Application No. 2020-135356, filed on Aug. 7, 2020, the entire contents of which are incorporated herein by reference.

### TECHNICAL FIELD

The present disclosure relates to a method and a server.

### BACKGROUND

Technology for providing users with information is known. For example, Patent Literature (PTL) 1 discloses an information transmission apparatus that allows a user who is meeting another user to send a message to that other user.

### CITATION LIST

### Patent Literature

PTL 1: JP 2005-003592 A

### SUMMARY

Improvement of technology for providing users with information is desired.

It would be helpful to improve technology for providing users with information.

A method according to an embodiment of the present disclosure is a method executed by a terminal apparatus, the method including:

transmitting and receiving one or more instant messages among a plurality of users;

acquiring a period for sharing positional information among the plurality of users, the period being determined based on a meeting time for the plurality of users that is acquired from the instant messages;

activating a function of sharing positional information among the plurality of users, when the period starts; and

deactivating the function when the period ends.

A method according to an embodiment of the present disclosure is a method executed by a server, the method including:

acquiring one or more instant messages transmitted and received among a plurality of users;

acquiring a meeting time for the plurality of users from the instant messages;

activating a function of sharing positional information among the plurality of users, when a period for sharing positional information among the plurality of users starts, the period being determined based on the meeting time; and

deactivating the function when the period ends.

A server according to an embodiment of the present disclosure is a server including:

a communication interface; and

a controller configured to communicate via the communication interface,

wherein the controller is configured to:

acquire one or more instant messages transmitted and received among a plurality of users;

acquire a meeting time for the plurality of users from the instant messages;

activate a function of sharing positional information among the plurality of users, when a period for sharing positional information among the plurality of users starts, the period being determined based on the meeting time; and

deactivate the function when the period ends.

According to an embodiment of the present disclosure, technology for providing users with information is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of a server;

FIG. 4 is a diagram illustrating an example of a user database stored in the server;

FIG. 5 is a diagram illustrating an example of a vehicle database stored in the server;

FIG. 6 is a sequence diagram illustrating first operations of the system;

FIG. 7 is a sequence diagram illustrating second operations of the system;

FIG. 8 is a sequence diagram illustrating third operations of the system; and

FIG. 9 is a sequence diagram illustrating fourth operations of the system.

### DETAILED DESCRIPTION

Hereinafter, an embodiment of the present disclosure will be described.

### Summary of Embodiment

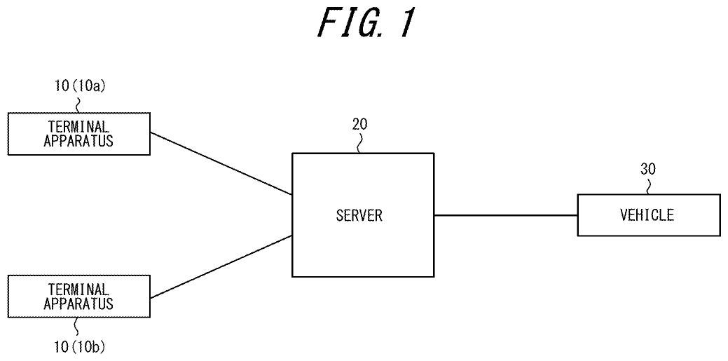

An outline of a system 1 according to an embodiment of the present disclosure will be described with reference to FIG. 1. The system 1 includes a plurality of terminal apparatuses 10, a server 20, and a vehicle 30. Two terminal apparatuses 10 (10a and 10b) are illustrated in FIG. 1; however, the number of terminal apparatuses 10 included in the system 1 may be any number not less than two. One vehicle 30 is illustrated in FIG. 1; however, the number of vehicles 30 included in the system 1 may be two or more. The server 20 is communicably connected to the terminal apparatuses 10 and the vehicle 30.

Each of the terminal apparatuses 10 is any information processing apparatus that a user can use. For example, a general purpose information processing apparatus such as a smartphone, a tablet terminal, or a personal computer (PC) may be used as each of the terminal apparatuses 10. The server 20 includes a single information processing apparatus or multiple information processing apparatuses that can communicate with each other. The server 20 has a messaging function of relaying instant messages (hereinafter, simply referred to as “messages”) transmitted and received among a plurality of users using the terminal apparatuses 10. The server 20 is used, for example, to provide a messaging service for transmitting and receiving messages among a plurality of users participating in a virtual chat room. In the present embodiment, “messages” include text data, image data, voice data, or a combination of these. The vehicle 30 is an automobile, for example, but not limited to this, and may be any vehicle that a person can board. The vehicle 30 may be capable of automated driving such as any one of Level 1 to Level 5 as defined by the Society of Automotive Engineers (SAE), for example. The vehicle 30 may be used as a drop-off/pick-up vehicle for dropping off and picking up users as described later.

First, an outline of the present embodiment will be described, and details thereof will be described later. The terminal apparatuses 10 transmit and receive messages among a plurality of users via the server 20. Hereinafter, transmitting and receiving of messages among users will also be simply referred to as chatting. Suppose that the plurality of users chats and arranges to meet. The server 20 acquires a meeting time for the plurality of users from transmitted and received messages. The server 20 determines, based on the meeting time, and acquires a period for sharing positional information among the plurality of users (hereinafter, also referred to as a “sharing period”). The terminal apparatuses 10 and the server 20 each activate a corresponding function of sharing positional information among the plurality of users (hereinafter, also referred to as a “sharing function”) when the sharing period starts. Then, the terminal apparatuses 10 and the server 20 each deactivate the corresponding sharing function when the sharing period ends.

As described above, according to the present embodiment, for example, positional information sharing functions are activated when a meeting time approaches, and thus the complexity of having a plurality of users meet at a meeting place may be reduced. The positional information sharing functions are automatically deactivated over time, and thus privacy may be protected among the plurality of users. Therefore, technology for providing users with information is improved in that privacy is protected while the complexity of meeting is reduced.

Next, configurations of the system 1 will be described in detail.

(Configuration of Terminal Apparatus)

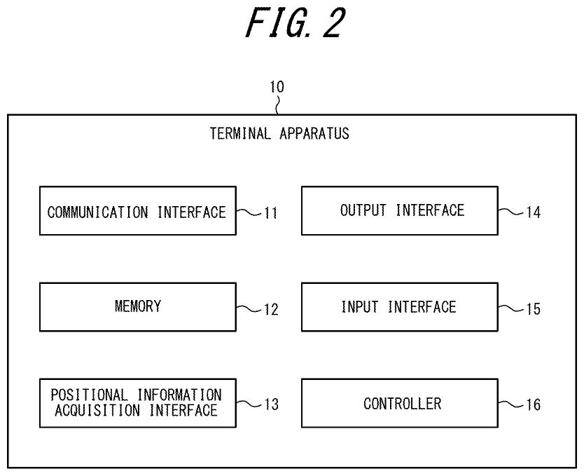

As illustrated in FIG. 2, each of the terminal apparatuses 10 include a communication interface 11, a memory 12, a positional information acquisition interface 13, an output interface 14, an input interface 15, and a controller 16.

The communication interface 11 includes at least one communication interface for connecting to the network. The communication interface is compliant with a mobile communication standard such as the 4th generation (4G) standard or the 5th generation (5G) standard, or a wired local area network (LAN) standard or a wireless LAN standard, for example, but not limited to these. In the present embodiment, each of the terminal apparatus 10 is communicably connected with the server 20 via the corresponding communication interface 11 and the network.

The memory 12 includes one or more memories. The memories are semiconductor memories, magnetic memories, optical memories, or the like, for example, but are not limited to these. The memories included in the memory 12 may each function as, for example, a main memory, an auxiliary memory, or a cache memory. The memory 12 stores any information used for operations of the corresponding terminal apparatus 10. For example, the memory 12 may store a system program, an application program, embedded software, and the like. The information stored in the memory 12 may be updated with, for example, information acquired from the network via the communication interface 11.

In the present embodiment, the memory 12 stores at least one application program for using the messaging service. The application program, for example, may be downloaded from an external application distribution server, or may be preinstalled when the corresponding terminal apparatus 10 is manufactured. When the application program is executed, for example, a screen for chatting may be displayed. The operations of each of the terminal apparatuses 10 according to the present embodiment may be realized by a single application program, or may be realized by coordination of multiple application programs.

The positional information acquisition interface 13 includes at least one device for acquiring positional information for the corresponding terminal apparatus 10. Specifically, the positional information acquisition interface 13 is a receiver corresponding to the Global Positioning System (GPS), for example, but is not limited to this, and may be a receiver corresponding to any satellite positioning system. In the present embodiment, the positional information acquired by the positional information acquisition interface 13 is used as positional information for a user of the corresponding terminal apparatus 10.

The output interface 14 includes at least one output device for outputting information to notify the user of the information. The output device is a display for outputting information as video, a speaker for outputting information as audio, or the like, for example, but is not limited to these.

The input interface 15 includes at least one input device for detecting user input. The input device is a physical key, a capacitive key, a touch screen integrally provided with a display of the output interface 14, a microphone for accepting audio input, or the like, for example, but is not limited to these.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 16 controls the operations of the entire corresponding terminal apparatus 10. Details of the operations of the corresponding terminal apparatus 10 controlled by the controller 16 will be described later.

(Configuration of Server)

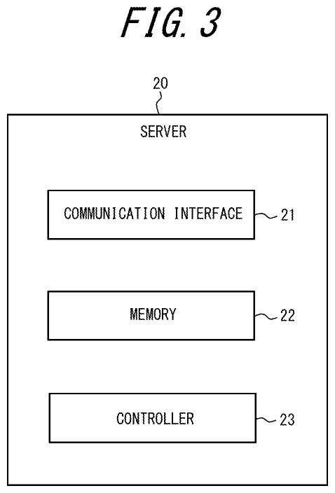

As illustrated in FIG. 3, the server 20 includes a communication interface 21, a memory 22, and a controller 23.

The communication interface 21 includes at least one communication interface for connecting to the network. The communication interface is compliant with a wired LAN standard or a wireless LAN standard, for example, but is not limited to these. In the present embodiment, the server 20 is communicably connected with the terminal apparatuses 10 via the communication interface 21 and the network.

The memory 22 includes one or more memories. The memories are semiconductor memories, magnetic memories, optical memories, or the like, for example, but are not limited to these. The memories included in the memory 22 may each function as, for example, a main memory, an auxiliary memory, or a cache memory. The memory 22 stores any information used for operations of the server 20. For example, the memory 22 may store a system program, an application program, a database, and the like. The information stored in the memory 22 may be updated with, for example, information acquired from the network via the communication interface 21. In the present embodiment, the memory 22 stores a user database and a vehicle database.

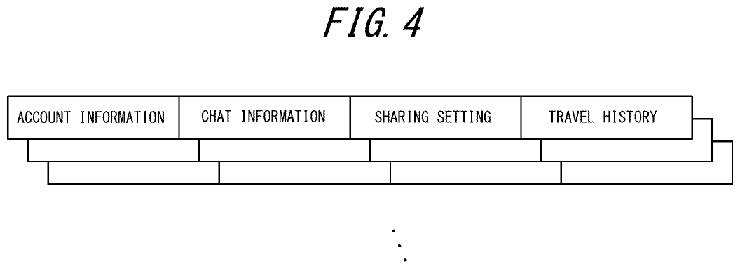

The user database includes any information regarding users of the messaging service provided using the server 20. For example, in the example illustrated in FIG. 4, the user database includes “account information”, “chat information”, a “sharing setting”, and a “travel history” for each user.

Account information includes any information regarding a user who is to use the messaging service. The account information includes a login ID and a password for logging in to the messaging service, a user ID, a username, and payment information (e.g., credit card information, bank account information, or the like), for example, but is not limited to these.

Chat information includes, for example, one or more messages transmitted and received by a user for each virtual chat room. Messages accumulated in the chat information may be deleted, for example, when a certain time period has elapsed.

A sharing setting is information indicating whether to allow positional information to be shared by the sharing functions described above. The sharing setting can be set at any time, for example, by a user using a terminal apparatus 10.

A travel history includes time series data of positional information transmitted from a terminal apparatus 10 of a user to the server 20.

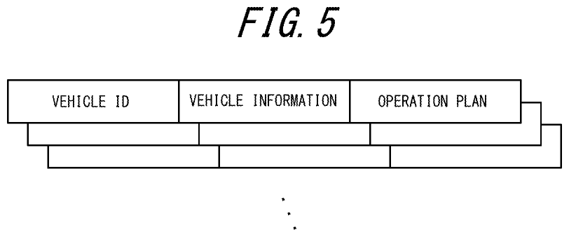

The vehicle database includes any information regarding the vehicle 30. For example, in the example illustrated in FIG. 5, the vehicle database includes a “vehicle ID”, “vehicle information”, and an “operation plan” for each vehicle 30.

A vehicle ID is information uniquely identifying a vehicle 30, such as a vehicle number, for example.

Vehicle information includes any information regarding a vehicle 30. The vehicle information includes the name, the vehicle type, an exterior image, driver information, positional information, and the like with respect to the vehicle 30, for example, but is not limited to these. The positional information, for example, is periodically notified from the vehicle 30 to the server 20 and is accumulated in the vehicle database.

An operation plan includes any information regarding an operation plan for a vehicle 30. The operation plan includes information such as a reserved time slot for which drop-off and pick-up of a user have been reserved, and a drop-off/pick-up route, for example, but is not limited to this. The vehicle 30 can be used for dropping off and picking up users except for the reserved time slot. The operation plan is notified from the server 20 to the vehicle 30 each time it is updated, or periodically. The vehicle 30 drops off and picks up users in accordance with the notified operation plan.

The controller 23 illustrated in FIG. 3 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 23 controls the operations of the entire server 20. Details of the operations of the server 20 controlled by the controller 23 will be described later.

(Flow of Operations of System)

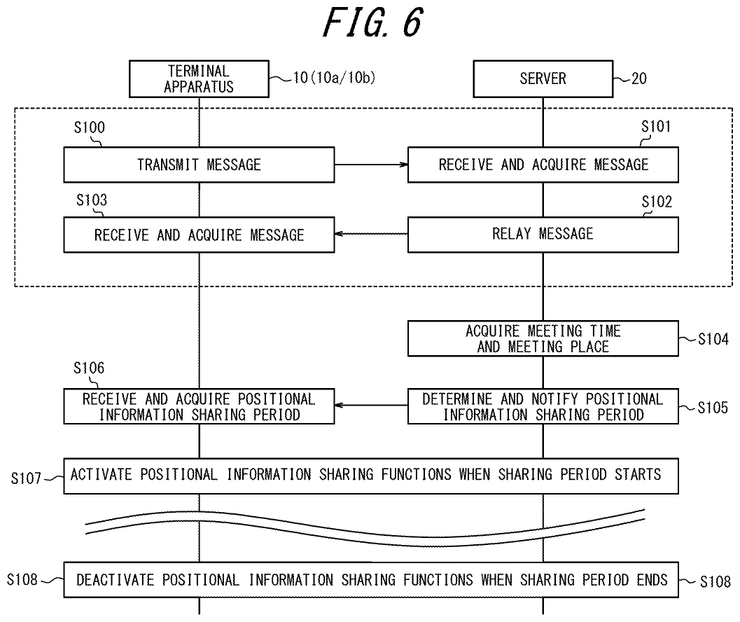

First to fourth operations of the system 1 will be described with reference to FIGS. 6 to 9. For simplicity of explanation, it is assumed that messages are transmitted and received between a first user of the terminal apparatus 10a and a second user of the terminal apparatus 10b; however, messages may be transmitted and received among three or more users.

Schematically, the first operations illustrated in FIG. 6 include operations of transmitting and receiving messages between the users, operations of determining a positional information sharing period, operations of switching between active and inactive states of positional information sharing functions, and the like.

Step S100: The controller 16 of the terminal apparatus 10a or 10b transmits a message. For simplicity of explanation, it is assumed that the controller 16 of the terminal apparatus 10a of the first user has transmitted a message addressed to the second user.

Step S101: The controller 23 of the server 20 receives and acquires the message of step S100.

Step S102: The controller 23 of the server 20 stores the acquired message in the memory 22, and relays the message.

In detail, the controller 23 adds the message addressed to the second user acquired from the terminal apparatus 10a of the first user to corresponding chat information for each of the first user and the second user, and transmits the message to the terminal apparatus 10b of the second user.

Step S103: The controller 16 of the terminal apparatus 10a or 10b receives and acquires the message relayed in step S102. Here, the controller 16 of the terminal apparatus 10b of the second user receives and acquires the message from the first user.

By repeating above steps S100 to S103, messages are transmitted and received between the first user and the second user. Suppose that the first user and the second user have had a dialogue through transmitting and receiving the messages, and have arranged to meet.

Step S104: The controller 23 of the server 20 acquires information on a meeting time and a meeting place from the messages transmitted and received between the first user and the second user.

In detail, the controller 23 refers to the messages transmitted and received between the first user and the second user from the chat information in the memory 22, and analyzes the content of the dialogue, thereby acquiring the information on the meeting time and the meeting place.

Any method can be employed to analyze the content of the dialogue. For example, the controller 23 may acquire the information on the meeting time and the meeting place using natural language processing. Specifically, for example, when the controller 23 detects that an arrangement to meet has been made from a natural language dialogue such as “How about meeting at station A?”, “Good, at 13:00”, and “OK”, the controller 23 acquires the meeting time and the meeting place as “13:00” and “station A”, respectively.

Alternatively, for example, the controller 23 may acquire the information on the meeting time and the meeting place as specified in a predetermined format in the messages. Specifically, for example, when the controller 23 detects that the messages include text in a format as “Meeting time: 13:00” and “Meeting place: station A”, the controller 23 acquires the meeting time and the meeting place as “13:00” and “station A”, respectively.

Step S105: The controller 23 of the server 20 determines a sharing period for sharing positional information between the first user and the second user based on the meeting time acquired in step S104, and notifies the terminal apparatuses 10a and 10b of the sharing period.

Any method can be employed to determine the sharing period. For example, the controller 23 may determine, as the sharing period, a period of a predetermined length with the meeting time as the end time. Alternatively, for example, the controller 23 may determine, as the sharing period, a period of a predetermined length including the meeting time. The length of the sharing period may be predetermined or may be specified by a user.

Step S106: The corresponding controller 16 of each of the terminal apparatuses 10a and 10b receives and acquires information on the positional information sharing period from the server 20. By such operations, information on the sharing period is shared between the terminal apparatuses 10a and 10b and the server 20.

Step S107: The controller 16 of the terminal apparatus 10a, the controller 16 of the terminal apparatus 10b, and the controller 23 of the server 20 each activate a corresponding sharing function of sharing positional information between the first user and the second user, when the sharing period starts. The second to fourth operations described later can be performed when the sharing functions are active.

Step S108: The controller 16 of the terminal apparatus 10a, the controller 16 of the terminal apparatus 10b, and the controller 23 of the server 20 each deactivate the corresponding sharing function activated in step S107 when the sharing period ends.

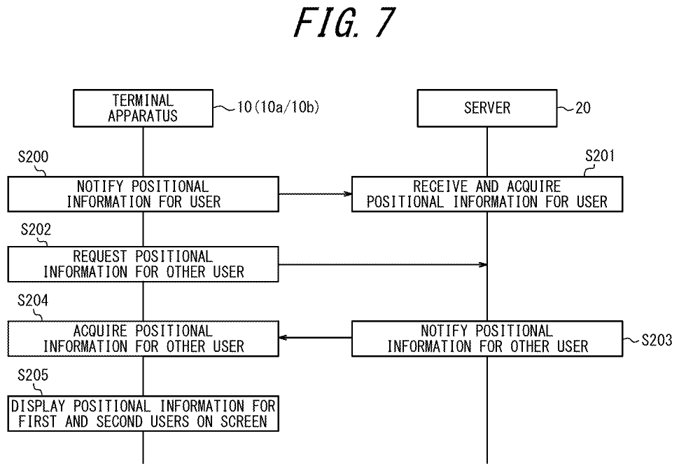

The second operations illustrated in FIG. 7 may be performed when the positional information sharing functions are active. Schematically, the second operations include operations of displaying, on a screen of each of the terminal apparatuses 10, positional information for a plurality of users who has arranged to meet by chatting, and the like.

Step S200: The controller 16 of the terminal apparatus 10a and the controller 16 of the terminal apparatus 10b notify the server 20 of positional information for the first user and positional information for the second user, respectively.

Step S201: The controller 23 of the server 20 receives and acquires the positional information of step S200, and stores the positional information in the memory 22. In detail, the controller 23 adds the positional information received from the terminal apparatus 10a and the positional information received from the terminal apparatus 10b to a travel history of the first user and a travel history of the second user in the user database, respectively.

By repeating above steps S200 and S201, positional information for the first user and the second user is accumulated in the server 20 as travel histories. Therefore, the travel histories each indicate time variation of the positional information for the corresponding user. Steps S200 and S201, for example, may be performed periodically or may be performed each time a predetermined trigger event (e.g., an event that either of the terminal apparatuses 10 has entered a sleep state) occurs.

Step S202: The controller 16 of the terminal apparatus 10a or 10b requests, for example, in response to user input via the input interface 15, the positional information for the other user from the server 20. For simplicity of explanation, it is assumed that the terminal apparatus 10a has requested the positional information for the second user from the server 20.

Step S203: The controller 23 of the server 20 notifies the terminal apparatus 10a or 10b of the positional information for the other user requested in step S202. For example, the controller 23 notifies the terminal apparatus 10a of the positional information for the second user requested by the terminal apparatus 10a of the first user.

Step S204: The controller 16 of the terminal apparatus 10a or 10b acquires the positional information for the other user notified by the server 20. For example, the terminal apparatus 10a of the first user acquires the positional information for the second user from the server 20.

Step S205: The controller 16 of the terminal apparatus 10a or 10b displays the positional information for the first user and the second user on a screen of the corresponding output interface 14. By such operations, the user of either of the terminal apparatuses 10 can see, in addition to the positional information for the user, the positional information for the other user with whom the user has arranged to meet by chatting. The positional information for the plurality of users, for example, may be displayed in a screen for chatting or may be displayed in another screen a transition to which occurs from the screen for chatting.

The terminal apparatuses 10 may display the positional information for the plurality of users on the screen except for a user who has not allowed positional information to be shared in a corresponding sharing setting. For example, suppose that three users from the first user to a third user have arranged to meet by chatting, and only the second user has not allowed positional information to be shared. In such a case, for example, even if the first user requests positional information for the second user and the third user, the server 20 notifies the terminal apparatus 10a of the first user of only the positional information for the third user, and the terminal apparatus 10a displays the positional information for the first user and the third user on the screen. According to such a configuration, the privacy of users who are not willing to share positional information may be protected.

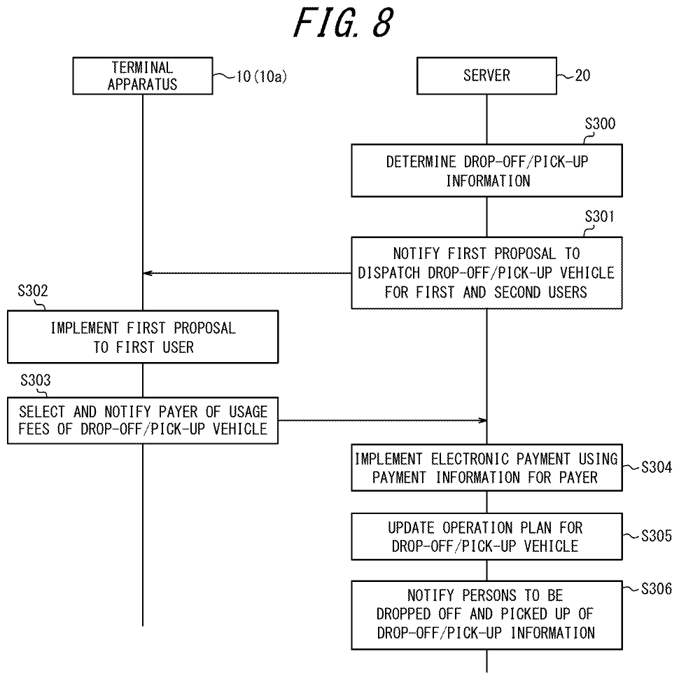

The third operations illustrated in FIG. 8 may be performed when the positional information sharing functions are active. Schematically, the third operations include operations of dispatching a drop-off/pick-up vehicle for a user, and the like.

Step S300: The controller 23 of the server 20 determines information on a drop-off/pick-up vehicle that can be dispatched for the first user and/or the second user who are determined to miss the meeting time (hereinafter, also referred to as “drop-off/pick-up information”). The drop-off/pick-up information includes information such as the vehicle ID, vehicle information (the vehicle type, an exterior image, positional information, and the like), positional information for boarding locations, boarding times, and usage fees with respect to the drop-off/pick-up vehicle, for example, but is not limited to this, and may include any information for the users to use the drop-off/pick-up vehicle.

In detail, the controller 23 determines whether the first user and the second user can arrive at the meeting place by the meeting time based on the respective travel histories, namely, the time variation of the positional information for the first user and the second user. Any method can be employed for the determination. For example, the controller 23 calculates the travel speed of a user based on the time variation of the positional information. The controller 23 may infer the means of travel of the user (e.g., on foot, by train, or the like) based on the travel speed, the positional information, map information, traffic information, and the like. The controller 23 performs a route search using the positional information for the user, the travel speed and/or the means of travel of the user, the map information, the traffic information, and the like, and acquires an estimated arrival time for the meeting place. In a case in which the estimated arrival time is later than the meeting time, the controller 23 determines that the user cannot arrive at the meeting place by the meeting time (i.e., the user is to miss the meeting time).

Then, upon determining that the first user and/or the second user cannot arrive at the meeting place by the meeting time, the controller 23 identifies a drop-off/pick-up vehicle that can be dispatched for the users who are determined to miss the meeting time, and determines drop-off/pick-up information for the drop-off/pick-up vehicle. Any method can be employed to determine the drop-off/pick-up information.

For example, in a case in which the means of travel of a user is on foot, the controller 23 may identify, as a drop-off/pick-up vehicle that can be dispatched for the user, one vehicle 30 from among one or more vehicles 30 that can be used, prioritizing the vehicle 30 with the shortest time distance to the user. The controller 23 determines the current position of the user as a boarding location, determines an estimated time at which the drop-off/pick-up vehicle is to arrive at the boarding location as a boarding time, and determines a usage fee of the drop-off/pick-up vehicle based on the boarding location and the meeting place. Then, the controller 23 determines the drop-off/pick-up information using the vehicle ID, vehicle information, positional information for the boarding location, the boarding time, information on the usage fee, and the like with respect to the drop-off/pick-up vehicle.

For example, in a case in which the means of travel of a user is by train, the controller 23 may identify, as a drop-off/pick-up vehicle that can be dispatched for the user, one vehicle 30 from among one or more vehicles 30 that can be used, prioritizing the vehicle 30 with the shortest time distance to the station at which the user is expected to get off based on a result of the route search described above. The controller 23 determines the station as a boarding location, determines an estimated time at which the drop-off/pick-up vehicle is to arrive at the boarding location as a boarding time, and determines a usage fee of the drop-off/pick-up vehicle based on the boarding location and the meeting place. The controller 23 determines the drop-off/pick-up information using the vehicle ID, vehicle information, positional information for the boarding location, the boarding time, information on the usage fee, and the like with respect to the drop-off/pick-up vehicle.

Step S301: The controller 23 of the server 20 notifies the terminal apparatuses 10a and/or 10b of a first proposal. The first proposal is a proposal to dispatch a drop-off/pick-up vehicle for the first user and/or the second user who are determined to miss the meeting time. The notification of the first proposal includes notification of any information prompting use of the drop-off/pick-up vehicle. For example, the notification of the first proposal includes notification of the drop-off/pick-up information of step S300 and of a message prompting use of the drop-off/pick-up vehicle. For simplicity of explanation, it is assumed that the terminal apparatus 10a of the first user has been notified of the first proposal.

Step S302: The controller 16 of the terminal apparatus 10a implements the first proposal of step S301 to the first user. In detail, the controller 16 of the terminal apparatus 10a outputs, via the output interface 14, the drop-off/pick-up information and the message notified from the server 20 in step S301, and notifies the first user of the drop-off/pick-up information and the message.

Step S303: The controller 16 of the terminal apparatus 10a selects a payer of usage fees of the drop-off/pick-up vehicle in response to user input via the input interface 15, and notifies the server 20 of the payer. In the present embodiment, the payer of the usage fees is selected, for example, from among the first user and the second user who chat. However, a third party different from the first user and the second user who chat may be selected as the payer. Two or more users may be selected as payers. In a case in which the first user does not accept the first proposal and the above user input to the terminal apparatus 10a is not entered, step S303 to step S306 are omitted.

Step S304: The controller 23 of the server 20 implements electronic payment of the usage fees of the drop-off/pick-up vehicle using payment information for the payer selected in step S303. In a case in which another user other than the first user is included as a payer in step S303, the controller 23 may transmit a request for confirmation of payment to a terminal apparatus 10 of the other user, and implement the electronic settlement upon receiving a response to allow payment from the other user.

Step S305: The controller 23 of the server 20 updates the operation plan for the drop-off/pick-up vehicle in the vehicle database based on the drop-off/pick-up information. In detail, the controller 23 updates the operation plan for the drop-off/pick-up vehicle so that the drop-off/pick-up vehicle drops off and picks up persons to be dropped off and picked up (here, the first user and/or the second user), specifically so that the drop-off/pick-up vehicle travels to the respective boarding locations of the persons and then travels to the meeting place with the persons on board.

Step S306: The controller 23 of the server 20 notifies the respective terminal apparatuses 10 of the persons to be dropped off and picked up of the drop-off/pick-up information. Each of the persons to be dropped off and picked up can board the drop-off/pick-up vehicle at the corresponding boarding location by checking the drop-off/pick-up information via the corresponding terminal apparatus 10. In a case in which the first user is included in the persons to be dropped off and picked up, the terminal apparatus 10a of the first user has already been notified of the drop-off/pick-up information in step S301; therefore, the notification of the drop-off/pick-up information to the terminal apparatus 10a may be omitted in step S306.

In a case in which both the first user and the second user are determined to miss the meeting time in above steps S300 to S306, a total of two drop-off/pick-up vehicles, one of which is a drop-off/pick-up vehicle for the first user and the other is a drop-off/pick-up vehicle for the second user, may be dispatched, or a single drop-off/pick-up vehicle that the first user and the second user are to board together. In above step S301, both of the terminal apparatuses 10a and 10b may be notified of the first proposal.

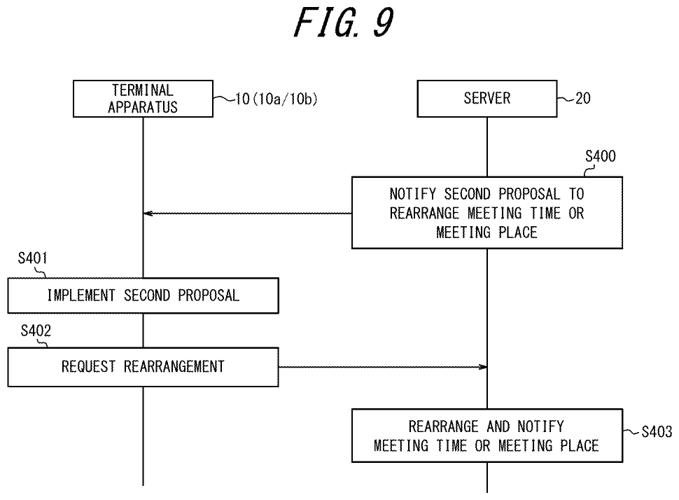

The fourth operations illustrated in FIG. 9 may be performed when the positional information sharing functions are active. Schematically, the fourth operations include operations of rearranging the meeting time and/or the meeting place, and the like.

Step S400: In a case in which the first user and/or the second user are determined to miss the meeting time, the controller 23 of the server 20 notifies the terminal apparatuses 10a and/or 10b of a second proposal to rearrange the meeting time and/or the meeting place. The notification of the second proposal includes notification of any information prompting the users to rearrange the meeting time and/or the meeting place. For example, the notification of the second proposal includes notification of a message indicating that the first user and/or the second user is to miss the meeting time and of a message prompting rearrangement of the meeting time and/or the meeting place.

In detail, the controller 23 determines whether the first user and the second user can arrive at the meeting place by the meeting time based on the respective travel histories, namely, the time variation of the positional information for the first user and the second user. Any method can be employed for the determination in the same manner as above step S300. Then, upon determining that the first user and/or the second user cannot arrive at the meeting place by the meeting time, the controller 23 notifies the terminal apparatuses 10a and/or 10b of the second proposal. For simplicity of explanation, it is assumed that the terminal apparatus 10a of the first user has been notified of the second proposal.

Step S401: The controller 16 of the terminal apparatus 10a implements the second proposal to the first user. In detail, the controller 16 of the terminal apparatus 10a outputs, via the output interface 14, the message notified from the server 20 in step S401, and notifies the first user of the message.

Step S402: The controller 16 of the terminal apparatus 10a requests, for example, in response to predetermined user input via the input interface 15, rearrangement of the meeting time and/or the meeting place from the server 20. In detail, the controller 16 notifies the server 20 of a new meeting time and/or a new meeting place input via the input interface 15, and requests the rearrangement.

Step S403: The controller 23 of the server 20 rearranges the meeting time and/or the meeting place in response to the request from the terminal apparatus 10a, and notifies the terminal apparatuses 10a and 10b of the rearranged meeting time and the rearranged meeting place. The controller 23 may deactivate the corresponding positional information sharing function, and return to the operations in above step S105 to newly determine a positional information sharing period.

As described above, in the system 1 according to the present embodiment, the terminal apparatuses 10 transmit and receive one or more messages among a plurality of users. The server 20 determines a positional information sharing period based on a meeting time acquired from the messages. The terminal apparatuses 10 each acquire the sharing period. The terminal apparatuses 10 and the server 20 each activate a corresponding positional information sharing function when the sharing period starts. Then, the terminal apparatuses 10 and the server 20 each deactivate the corresponding sharing function when the sharing period ends.

According to such a configuration, for example, positional information sharing functions are activated when a meeting time approaches, and thus the complexity of having a plurality of users meet at a meeting place may be reduced. The positional information sharing functions are automatically deactivated over time, and thus privacy may be protected among the plurality of users. Therefore, technology for providing users with information is improved in that privacy is protected while the complexity of meeting is reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which each or any of the terminal apparatuses 10 executes some or all of the operations that are executed by the server 20 in the embodiment described above can be implemented. An embodiment in which the server 20 instead executes some of the operations executed by each or any of the terminal apparatuses 10 can be implemented. An embodiment in which multiple information processing apparatuses that can communicate with each other perform distributed processing of some or all of the operations executed by the server 20 can be implemented. For example, a first server of a messaging service provider and a second server of a vehicle dispatch service provider may cooperate, thereby executing operations similar to those of the server 20.

For example, an embodiment in which a general purpose information processing apparatus functions as each or any of the terminal apparatuses 10 or the server 20 according to the embodiment described above can also be implemented. Specifically, a program in which processes for realizing the functions of each or any of the terminal apparatuses 10 or the server 20 according to the above-described embodiment are written may be stored in a memory of the information processing apparatus, and the program may be read and executed by a processor of the information processing apparatus. Accordingly, the present disclosure can also be implemented as a program executable by a processor, or a non-transitory computer readable medium storing the program.

1. A method executed by a terminal apparatus, the method comprising:
transmitting and receiving one or more instant messages among a plurality of users;
acquiring a period for sharing positional information among the plurality of users, the period being determined based on a meeting time for the plurality of users that is acquired from the instant messages;
activating a function of sharing positional information among the plurality of users, when the period starts; and
deactivating the function when the period ends.

2. The method according to claim 1, further comprising displaying positional information for the plurality of users on a screen when the function is active.

3. The method according to claim 2, wherein the terminal apparatus displays the positional information for the plurality of users on the screen except for a user who has not allowed positional information to be shared.

4. The method according to claim 1, further comprising implementing, to a first user of the terminal apparatus, a first proposal to dispatch a drop-off/pick-up vehicle for the first user and/or a second user different from the first user based on time variation of positional information for the first user and the second user, the meeting time, and a meeting place for the plurality of users that is acquired from the instant messages.

5. The method according to claim 4, further comprising selecting a payer of a usage fee of the drop-off/pick-up vehicle when implementing the first proposal.

6. The method according to claim 4, wherein the terminal apparatus implements the first proposal in a case in which it is determined that the first user and/or the second user cannot arrive at the meeting place by the meeting time based on the time variation of the positional information for the first user and the second user.

7. The method according to claim 4, further comprising implementing, to the first user, a second proposal to rearrange the meeting time and/or the meeting place in a case in which it is determined that the first user and/or the second user cannot arrive at the meeting place by the meeting time based on the time variation of the positional information for the first user and the second user.

8. A method executed by a server, the method comprising:
acquiring one or more instant messages transmitted and received among a plurality of users;
acquiring a meeting time for the plurality of users from the instant messages;
activating a function of sharing positional information among the plurality of users, when a period for sharing positional information among the plurality of users starts, the period being determined based on the meeting time; and
deactivating the function when the period ends.

9. The method according to claim 8, further comprising transmitting positional information for the plurality of users to a terminal apparatus when the function is active.

10. The method according to claim 9, wherein the server transmits the positional information for the plurality of users to the terminal apparatus except for a user who has not allowed positional information to be shared.

11. The method according to claim 8, further comprising:
acquiring a meeting place for the plurality of users from the instant messages; and
notifying a terminal apparatus of a first user of a first proposal to dispatch a drop-off/pick-up vehicle for the first user and/or a second user based on time variation of positional information for the first user and the second user, the meeting time, and the meeting place.

12. The method according to claim 11, further comprising implementing electronic payment of a usage fee of the drop-off/pick-up vehicle using payment information for a payer selected by the terminal apparatus of the first user in response to the first proposal.

13. The method according to claim 11, wherein the server notifies the terminal apparatus of the first user of the first proposal in a case in which it is determined that the first user and/or the second user cannot arrive at the meeting place by the meeting time based on the time variation of the positional information for the first user and the second user.

14. The method according to claim 11, further comprising notifying the terminal apparatus of the first user of a second proposal to rearrange the meeting time and/or the meeting place in a case in which it is determined that the first user and/or the second user cannot arrive at the meeting place by the meeting time based on the time variation of the positional information for the first user and the second user.

15. A server comprising:
a communication interface; and
a controller configured to communicate via the communication interface,
wherein the controller is configured to:
acquire one or more instant messages transmitted and received among a plurality of users;
acquire a meeting time for the plurality of users from the instant messages;
activate a function of sharing positional information among the plurality of users, when a period for sharing positional information among the plurality of users starts, the period being determined based on the meeting time; and
deactivate the function when the period ends.

16. The server according to claim 15, wherein the controller is configured to transmit positional information for the plurality of users to a terminal apparatus when the function is active.

17. The server according to claim 16, wherein the controller is configured to transmit the positional information for the plurality of users to the terminal apparatus except for a user who has not allowed positional information to be shared.

18. The server according to claim 15, wherein the controller is configured to:
acquire a meeting place for the plurality of users from the instant messages; and
notify a terminal apparatus of a first user of a proposal to dispatch a drop-off/pick-up vehicle for the first user and/or a second user based on time variation of positional information for the first user and the second user, the meeting time, and the meeting place.

19. The server according to claim 18, wherein the controller is configured to implement electronic payment of a usage fee of the drop-off/pick-up vehicle using payment information for a payer selected by the terminal apparatus of the first user in response to the proposal.

20. The server according to claim 18, wherein the controller notifies the terminal apparatus of the first user of the proposal in a case in which it is determined that the first user and/or the second user cannot arrive at the meeting place by the meeting time based on the time variation of the positional information for the first user and the second user.
